(19) United States
(12) Patent Application Publication
(10) Pub. No.: US 2002/0087532 A1
(43) Pub. Date: Jul. 4, 2002

(54) Cooperative, interactive, heuristic system for the creation and ongoing modification of categorization systems

(76) Inventors: Steven Barritz, Syosset, NY (US); Robert Barritz, Syosset, NY (US)

Correspondence Address: OSTROLENK FABER GERB & SOFFEN, 1180 AVENUE OF THE AMERICAS, NEW YORK, NY, 100368403

(21) Appl. No.: 10/034,858

(22) Filed: Dec. 27, 2001

Related U.S. Application Data
(60) Provisional application No. 60/258,740, filed on Dec. 29, 2000.

(51) Int. Cl. G06F 7/00

(52) U.S. Cl. 707/3

(57) ABSTRACT

An Internet-related invention comprising hardware and software constructs that operate substantially interactively and, to a degree, automatically, to produce search categories and search attributes that facilitate the creation, indexing and searching for physical and informational items stored on Internet databases and the like. Thereby, hosts of databases or the listers of information on databases, are able to interactively and dynamically, modify, augment or correct attributes based on the activity of end searchers, business needs of listers and hosts and the like.

### RELATED CASE

This Application claims priority and is entitled to the filing date of U.S. Provisional Application Serial No. 60/258,740 filed Dec. 29, 2000, and entitled “A COOPERATIVE, INTERACTIVE, HEURISTIC SYSTEM FOR THE CREATION AND ONGOING MODIFICATION OF CATEGORIZATION SYSTEMS,” the contents of the provisional patent application are incorporated by reference herein.

### BACKGROUND OF THE INVENTION

The present invention relates to the Internet generally and, more particularly, to a substantially interactive and to a degree automated system that produces search categories and search attributes which facilitate the creation, indexing and searching for physical and informational items stored on Internet databases and the like.

The advent of the Internet has made everything available to everyone, everywhere. Information, text, merchandise, music, images, everything, it's all there. But often, the problem is finding what one wants.

Users may employ search engines (SEs) such as Google or Alta Vista, or systems such as Vivisimo or Metacrawler that agglomerate the results from one or more search engines, sometimes further processing those results.

SEs typically allow users to specify one or more keywords or phrases connected by Boolean conditions, then return to the user a list of results that are responsive to the keywords, usually including along with each result a few sentences of text, extracted from the corresponding webpage, so that the user can judge the actual relevance of each result. If a user wished to find a web retailer selling toasters, using “toasters” as a keyword to an SE such as Google or Hotbot will yield many dozens of toaster sellers. And if a specific toaster such as the Black & Decker T1400 is wanted, using “Black” and “Decker” and “T1400” as keywords will yield links to the websites of dozens of sellers of this particular item. Or the eBay auction site could be searched in a similar fashion using eBay's embedded search engine, and if such a toaster were currently on auction, it would very likely be found.

Or, instead of using an SE, users could consult a categorization system (CS) or a common variant, the hierarchical categorization system (HCS) such as the shopping guides provided by www.msn.com <http://www.msn.com>, www.netscape.com <http://www.netscape.com>, www.ebay.com <http://www.ebay.com>or www.dmoz.org <http://www.dmoz.org>. These systems present information on a great number of discrete items, which the HCS retains in an Item Data Base (IDB). Typical HCS systems provide a hierarchy or taxonomy that attempts to organize the subject matter in a tree structure, allowing a user to drill down through successive category layers to get progressively closer to the object of their search. Each item in the IDB is “tagged” with a set of categories that characterizes the item.

Very often an HCS will show, at each category level, all the items pertaining to that level. Moving to a category at the next lower level in effect filters out all items not belonging to that lower category. The user can proceed in this fashion until the number of items displayed is small enough to be readily scanned visually, or until the maximum category precision is reached. For example, to use the MSN system to search for the Black & Decker toaster, the user would first click on “Shopping” on the MSN home page. This would display another page containing about 20 categories including “Apparel”, “Autos”, “Books” and “Gourmet and Kitchen”. Clicking on “Gourmet and Kitchen” displays a page listing more categories including “Bakeware”, “Cookware” and “Kitchen Appliances”. Clicking on “Kitchen Appliances” displays a page containing several categories of appliances including “Small Appliances”, under which are listed types of small appliances, including “Toasters”. Clicking on “Toasters” displays a page that lists recommended toasters as well as links to some toaster sellers. Visiting a few of the web sites of these toaster sellers will quickly locate one that sells the Black & Decker T1400.

A key characteristic of the above example is that the desired merchandise can readily be categorized in a complete and consistent fashion by both buyer and seller, both of whom will likely describe it as “Black & Decker T1400”, ensuring that when SEs scan the text of seller websites these terms will be picked up and included in the SE databases. Another key characteristic is that the user doesn't greatly care whether all toaster sellers that carry the particular toaster have been located, so long as a sufficient number are located to allow for price and availability comparison.

But a great deal of merchandise can't readily be categorized as completely as the toaster in the example above, and is therefore much more difficult to successfully locate using either SEs or the available CSs. Consider the case of a user wishing to locate a particular type and style of chair, such as one in a contemporary style, with a high back and no arms, with a wood frame, and with a leather padded seat and back, using either green or blue leather. Using one of the SEs (Google) and performing a search for all the terms “chair” and “contemporary” and “high back” and “armless” and “wood frame” and “leather” (even leaving out the green or blue requirement) yields just four hits. And three of the hits are furniture glossaries, not furniture sellers, leaving just one valid seller of a chair having (most) of the desired attributes.

Using Hotbot produces similar results: eight hits altogether, only two of which represent furniture sellers. And though all the specified terms are used on these pages, they may not all pertain to a particular chair. A webpage might display a number of items, and as long as each of the specified terms is attached to some item, the webpage will satisfy the SE query. So, for example, a user might be directed to a webpage listing a Victorian chair, a contemporary painting, a high back bureau, an armless statue, a wood frame for the painting, and some leather shoes. And there may exist dozens or hundreds of webpages that in fact offer chairs having the exact desired attributes, but which are not described using the same text terms as the user employed in his SE query. For example, a chair might be described as “modern” instead of “contemporary”, or “without arms” instead of “armless”, or “wood construction” instead of “wood frame”, or one or more of the attributes may simply not be mentioned. In all these cases, such webpages will not be supplied to the user in response to his query.

For most items, existing HCSs will perform no better. An HCS will lead the user through successive hierarchical levels, but will almost never allow a selection or specification having the granularity of detail necessary to encompass the list of desired attributes for the aforementioned chair. For example, consulting eBay, the user would start with the main list of several dozen categories and might select “Collectibles”. Within the “Collectibles” category, the user would then select “Furniture”. The user would then find himself at the end of the road: eBay has no categories further subdividing “Furniture” under “Collectibles”, and therefore the best the user can now do is to use eBay's search engine to search within the entire “Furniture” category in the same manner as described above. Using MSN, the user would select “Shopping” from the main page, then “Home & Garden”, then “Furniture & furnishings”, then “Furniture”. At this point the hierarchy gives out, and the user must serially browse through all listed furniture, with all types intermingled.

Another deficiency of HCSs is that the user must guess or deduce the hierarchy of categories that the creator of the CS may have used that will lead to the desired item (or as close as possible to it). For example, in the above eBay example, the user followed the path Main>Collectibles>Furniture. But the “Antiques & Art” category also list a “Furniture” subcategory, so the user could alternatively have followed the Main>Antiques&Art>Furniture path. Or, the user might follow the Main>EverythingElse>HomeFurnishings>Furniture path, or perhaps the Main>EverythingElse>Household path. Any of these paths might contain the desired chairs, though the user can't know which one without examination. It might also be the case that several, or all, of these paths contain chairs having the desired attributes. Again, the user is obliged to perform a detailed inspection.

The difficulties associated with using HCSs is not restricted to searches for tangible goods or merchandise. The www.epicurious.com <http://www.epicurious.com>website maintains a database of 11,000 recipes that may be accessed via a HCS. Moreover, the hierarchy has been structured in such a way that there are many possible paths to a given goal. The user may choose from several main categories such as “Main Ingredient”, “Cuisine”, “Course” or “Preparation Method”. If the user wanted to find a Mexican broiled appetizer containing cheese, he could follow the path Cuisine>Mexican>Course>Appetizer>MainIngredient>Cheese>P reparation>Broil and discover that Avocado Quesadillas satisfy all his requirements. Alternatively, he could follow the path Course>Appetizers>Preparation>Broil>Cuisine>Mexican>Main Ingredient>Cheese, or Preparation>Broil>Mainingredient>Cheese>Cuisine>Mexican>Course>Appetizer and find the same recipe. But if the user wished to use additional criteria not thought of or provided by the creator of the HCS, the user must again rely on keyword searching. For example, if the user wanted to find a vegetarian and/or low fat recipe from amongst the recipes displayed by one of the above paths he would have to use the built-in SE to search within those recipes for appropriate keywords. But should he use “vegetarian” or “meatless”? Should he use “low fat” or “low calorie”, or perhaps “diet”, or “dietetic”? And it may well be that even a meatless recipe doesn't use the words “meatless” or “vegetarian” anywhere in the text of the recipe. These uncertainties further illustrate the unreliability and incompleteness of information derived from an HCS.

And, unlike a particular toaster model from a particular manufacturer, all instances of which are identical and can be ordered from any seller that carries them, users searching for items that have extensive qualitative differences, like chairs or shoes or recipes, usually want to locate not just a few of the item, but as many as possible items fitting the users detailed requirements so that a comparison can be made, and the most satisfactory item selected. Clearly, users would prefer to select a chair from a choice of 50 different chairs, all of which comply with the users detailed specifications, rather than from a choice of only three or six chairs. And even if a user would be happy to buy an item from any seller who carries it, it would be a lot easier to find a 12″ Freeberg silicon-bronze pipe wrench with a 3″ serrated jaw if it were possible to specify overall-size, wrench-make, wrench-material, jaw-size, and jaw-type than if it were necessary to search through all the items listed in the entire “wrench” category.

In theory, an HCS could provide all the granularity of detail that users might desire. There's no inherent reason that an HCS needs to stop at the level of “Furniture” or “Chair”—it certainly could include levels or attributes relating to the characteristics cited above such as period/style (contemporary, Bauhaus, early American, French Provincial, etc.), dominant color (blue, green, red, pistachio, fuchsia, etc.), frame material (metal, wood, rattan, etc.), seat material (leather, canvas, silk, etc.). But the HCS should then also encompass all the other attributes of chairs that any users might care about, such as type (dining chair, side chair, lounge chair, rocker, etc.), material pattern (solid, flowers, stripes, leopard spots, etc.), secondary color, price range, country of origin, dimensions, weight, and so on. And this detailed listing of attributes might have to be supplied for thousands of items. For example, eBay has more than 4,000 categories and subcategories, just one of which is “Chair” (actually, it's lumped together with “Tables”!) without any further subcategories supplied. And there's a category for “Parts & Tools”, with a subcategory of “Hand tools”, but nothing even as specific as “Wrench”, much less the level of detail described above.

If eBay's categories were fully expanded—if “Hand tools” led into all the appropriate subcategories and subsubcategories of “Hand tools”—the 4,000 categories might easily become 50,000 or 100,000. And most of those categories would require a further set of detailed attributes. So, despite the desirability, whether within ebay or elsewhere, of a fully detailed HCS, it typically represents not only a stupendous amount of work to create, it would also require vast and intimate knowledge of all the particulars of all the attributes of all the categories of items to be included, which is expertise that's not readily found these days.

Note that there are two types of HCSs. The first, typified by eBay, has one and only one path leading to a particular item. For example, if eBay had the path Collectibles>Furniture>DiningRoom>Tables, no items found via this path would also be found via the path Antiques>Furniture>Tables. We'll refer to those HCSs that have only a single path to any item as Single Path HCSs (SPHCSs). SPHCSs do not incorporate simple inversions of paths. For example, in eBay, there is no path Collectibles>Furniture>Tables>DiningRoom, which, if it existed, would be expected to lead to the identical set of items as Collectibles>Furniture>DiningRoom>Tables. Epicurious on the other hand contains this kind of inversion: as noted above, the path Cuisine>Mexican>Course>Appetizers>MainIngredient>Cheese>Preparation>Broil leads to the identical set of items as the path Course>Appetizers>Preparation>Broil>Cuisine>Mexican>Main Ingredient>Cheese. We'll call this type of path, which contains the identical categories as another path but in a different order, as an Inversion Path (IP). Moreover, paths composed in part of other categories may also lead to some of the same items. Some of the dishes found via the prior path may also be pointed to by the path Season/Occasion>Superbowl>MainIngredient>Cheese. We'll refer to those HCSs that may contain IPs or multiple paths to a given item as Networked HCSs (NHCSs).

Note that HCSs typically allow the user only a single choice at a particular category level, which will then take the user to the next lower category level.

Note also that an NHCS can include at a single category level characteristics that are not mutually exclusive (such as “Cuisine”, “MainIngredient” and “Course”) by also including those same characteristics at other category levels. Or an NHCS can display multiple groups of characteristics at a single level, with each characteristic in a particular group being mutually exclusive. When the user descends to a lower category level by choosing a characteristic from a particular group, the NHCS can repeat all the other groups at the lower level, as is done by Epicurious in the examples above. But a SPHCS must (or should) only include characteristics in a single category level that are mutually exclusive, so that as the user drills down through deeper levels, all the items that the user may be interested in continue to be within the path the user is following. For example, let's say that the path Shopping>Household>Furniture>Chairs brought the user to a set of category choices consisting of “Contemporary”, “Traditional”, “Shaker”, “Leather Covered”, “Fabric Covered”, “Arms” and “Armless”. If the user was seeking a contemporary chair, leather covered and armless, any choice he makes will leave some items of interest in a path not taken. Because of this problem, a SPHCS would have to spread these categories over several levels: “Contemporary”, “Traditional” and “Shaker” at one level, “Leather Covered” and “Fabric Covered” at another level, and “Arms” and “Armless” at still another level. A SPHCS would therefore require a great number of category levels to describe items in great detail.

There are other types of categorization systems, some non-hierarchical, such as an attribute categorization system (ACS). In an ACS, items are tagged with one or more attributes, and the attributes have no required relationship to one another. The ACS may display the attributes in any order it chooses, for example alphabetical, or even random. Users seeking an item select one or more attributes. The ACS then displays all items tagged with the selected attributes. Typically, the user is then permitted, if he wishes, to select additional attributes to further prune the set of displayed items. ACSs share many of the deficiencies cited above for HCSs.

Generally, there are three parties who use CSs. The proprietors of the CS who operate and host the CS are one such party: we'll refer to them as the “hosts”. Typical hosts include eBay, whose CS supports it's auction business, or MSN, which offers free use of its CS to generate web traffic. Other hosts might include organizations that operate CSs to be used by internal personnel, or by customers, for example, a master CS containing information on a company's entire line of products. Other parties are those who include or list items in the CS, and must determine the appropriate categorizations: we'll refer to them as “listers”. Listers include those individuals selling items through eBay, and the MSN personnel who maintain MSN's CS. The third parties are the end-users who utilize the CS to access information or find items: we'll refer to them as “searchers”. We'll refer to listers and searchers collectively and generally as “users”.

As described above, use of SEs often yields a proportion of unwanted (and possibly unexpected) results. For example, a search on the term “soap” will produce results related to “soap opera”, “handmade soap”, and “soap bubbles”, and also to “simple object access protocol”, known also by its SOAP acronym. Users may simply wade through all the results, ignoring those that are irrelevant. Or they may attempt to refine the search results by better qualifying the search terms, for example by reissuing the search using “soap and bath” if their interest is in that form of soap, or “soap and not opera” if they wish to exclude results related to soap opera while including all other results.

Certain SEs, or systems that further process the data produced by SEs, such as Vivisimo, attempt to organize the results of even initial searches into categories or contexts based on the content of the material found by the search. This is done using one of several techniques known in the art such as “document clustering” or “phrase extraction”. The resultant material may be presented to the user as a flat list, or may be presented in hierarchical form, as a tree. Clustering is typically performed dynamically, at the time a search request is made, rather than in advance. Using clustering, a search using the term “soap” would still produce an assortment of results for bath soap, soap operas, and simple object access protocol, but each of these categories of result would be presented in a group. The user could then explore the group or groups that appeared most relevant to the user's interest.

A crude variant of the clustering technique is to allow the user to manually specify a group of one or more search results and then request that the SE “find more like”. This causes the SE to consider the specified group as a cluster, then find additional results that match the cluster's characteristics.

The problem, even with techniques such as clustering, is that to “drill in” on a subject, to revise and refine the search request in order to obtain the greatest number of appropriate responses while minimizing the number of irrelevant responses, requires the active effort and attention of the user. Moreover, the success of the refinement process rests on the skill of the user, for example in determining the appropriate search terms to include or exclude from the subsequent searches.

Note that techniques exist in the art that monitor the act of a user clicking on a URL, with the identity of the subject URL being transmitted to an independent web server. For example, this technique, referred to herein as the Daisy Chain Linking Procedure (DCLP), is used by several services that provide dynamic translation of webpages, including the Alta Vista translation service. The DCLP technique consists of constructing links on webpages in such a way that they point not to the apparent target webpage (the page that the user expects to be taken to if the link is clicked) but to a separate, independent server, which receives the URL of the apparent target as a parameter (we will refer to a link constructed in this fashion as a Daisy Chain Link, DCL). The independent server is thus able to inspect, analyze or process the data comprising the target webpage, following which, the target webpage (which may or may not be modified by the independent server) is displayed to the user. Thus, the user may be completely unaware that the independent server has intervened. Moreover, if desired, the independent server can ensure that the above procedure is continued by modifying the links on the target webpage (as presented to the user) to DCLs. In this way, the independent server continues to be aware of each webpage visited by the user.

### SUMMARY OF THE INVENTION

It is an object of the present invention to provide a system and method which operates substantially interactively and to a degree in an automated manner so as to enable the creation of search categories and search attributes for use on the Internet. The overall effect of the invention is to facilitate the creation and indexing and searching for physical and informational items stored in Internet databases or storage places.

The invention allows both the creators and listers of information on the Internet, such as on websites and the like, as well as those who search for such information to tweak, improve and render in better condition the tools that enable the posting and searching of information on the Internet.

Thus, it is the object of the invention, called the Cooperative Categorization System (CCS), to provide a means whereby the creation of a detailed CS takes the form of a cooperative activity in which the users of the CS propose and supply additional categories and attributes to extend the CS to meet their needs, with the CCS system further shaping, refining and adapting the organization of information based on the observed behavior of the listers and searchers of the system.

In the preferred embodiment, the CCS, while primarily hierarchical in the manner of an NHCS, also employs attributes in the manner of an ACS.

It is a further object of the invention to provide a system and method which automatically achieves clustering of the results of search engines by observing the results referenced by the user, without requiring that the user actively specify additional or modified search terms.

The foregoing and other objects of the invention are realized by a system and process which uses the aforementioned cooperative categorization system of the present invention and also or alternatively uses a technique known as automatic clustering, which minimizes or eliminates the need for an SE user to successively refine his/her search terms in a manual fashion, in order to improve the relevance of results.

Other features and advantages of the present invention will become apparent from the following description of the invention which refers to the accompanying drawings.

### BRIEF DESCRIPTION OF THE DRAWINGS

FIG. 1 is a block diagram of various major components of the present invention.

### DETAILED DESCRIPTION OF THE INVENTION

For the purposes of the invention, in order the achieve the aim of providing a cooperative categorization system, initially, the host creates a skeletal set of hierarchical categories and attributes, manually or otherwise, containing sufficient detail for users to minimally use the system. CCS stores these categories, and their interrelationships, in the Categorization Data Base (CDB). The CDB is referred to by the CCS whenever it creates a display or selection screen, therefore changes to the CDB are manifested immediately as changes in the displayed hierarchy of categories and associated attributes.

Dynamically adding categories: Reverting to the CCS, when a lister enters a new item into an HCS system, he typically peruses the existing categories to find those that best fit the item. Using CCS, if the existing categories do not absolutely and completely define the item, the lister is given the opportunity to define one or more additional category choices, perhaps creating a new category level, as an expansion of an existing category path. For example, assume that the lister's current item is a contemporary chair, with a metal frame and blue leather upholstery, and the lister has navigated down the path “Home” (selections: “Bedding”, “Towels & Linens”, “Furniture”, “Dinnerware”, etc.) to Home>Furniture (selections: “Tables”, “Beds”, “Chairs”, “Bookcases”, etc.) to Home>Furniture>Chairs. Let's also assume that no further categorization exists within “Chairs”. The CCS allows the lister to create a new category, which the lister might choose to call “Style”, and to supply one or more selections within the category. The lister, in our present example, would create a selection called “Contemporary”, and might also add other selections that might occur to him such as “French Provincial” or “Shaker”. (The CCS automatically supplies an additional selection of “Other” to include any items not tagged to any other selection.) The lister then tags the current chair as being associated with the newly created “Contemporary” selection, just as he would have if the “Style” category and “Contemporary” selection had existed all along.

As a variant, if the “Style” category did in fact already exist, but only contained selections of “French Provincial” and “Shaker”, the lister would simply add the “Contemporary” selection.

In similar fashion, the lister would then proceed to create, under the “Contemporary” category, a “FrameType” category, with a selection of “Metal”. Under the “Metal” category he would create a “UpholsteryType” category with a selection of “Leather”. And under the “Leather” category he would create a “Color” category with a selection of “Blue”. The final path to the lister's chair would be Home>Furniture>Chairs>Style>Contemporary>Frametype>Metal>UpholsteryType>Leather>Color>Blue.

In addition to adding the lister's item to the IDB, the CCS adds the additional categories created by the lister to the CDB. Thus, not only is the additional item available to searchers, in the path described above, but the additional categories (“Contemporary”, “Frametype”, etc.) are immediately available to other listers, who can use them as—is to categorize their own items, or can add further categories or subcategories as they may find desirable. In this way, through use, and through the participation of the community of users of the particular CCS, the number of categories and their hierarchical relationships becomes extended and expanded to meet the needs of that community.

Dynamically adding attributes: Optionally, the CCS includes at one or more category levels a set of attributes, which are also recorded in the CDB. Each attribute is either individually selectable, for example via check boxes, independent of all other attributes (and potentially in addition to some or all of them), or is a member of a set of mutually exclusive attributes (which we'll call an “attribute set”) selectable, for example, via radio buttons (only one of which may be selected at any given time), or a drop down list, from which only one item may be chosen. For example, at the category level Home>Furniture>Chairs, instead of requiring the searcher to navigate further category selections as described above, the CCS may display further selection criteria as selectable attributes, as follows:

STYLE (choose one): French

Provincial/Contemporary/Shaker

FRAMETYPE (choose one): Metal/Wood

UPHOLSTERY TYPE (choose one): Fabric/Leather

MAIN-COLOR (choose one): Blue/Green/Red/Black/Purple/Brown

ADDITIONAL COLORS: Blue(yes/no), Green(yes/no), Red(yes/no), Black(yes/no), Purple(yes/no), Brown (yes/no)

And additional attributes pertaining to some or all chairs may be displayed as well, for example:

Bun Feet (yes/no)

Armless (yes/no)

Slat-back (yes/no)

Recliner (yes/no)

Rocker (yes/no)

PADDING TYPE (choose one): Foam/Down/Feathers/CottonBatting Patterned Fabric (yes/no)

As with categories, the CCS allows listers to create additional attributes, or additional members of attribute-sets, or entire additional attribute-sets. For example, a lister might extend the attributes available under “chair” by adding the following:

High-back (yes/no)

UPHOLSTERY TYPE (choose one): Fabric/Leather/Plastic

FABRIC PATTERN (choose one): Plaid/Stripes/PolkaDots/Squiggles

In the above example “High-back” is a new attribute, “Plastic” is a new member of the “UpholsteryType” attribute-set, and “FabricPattern”, with its associated members, is a wholly new attribute-set. Any added or augmented attributes are recorded in the CDB, and are immediately available to subsequent searchers and listers.

Adaptive attribute display: At a given category level, there may eventually be a very great number of attributes. For example, the attributes at the Home>Furniture level would not only pertain to chairs, and therefore include all the attributes described above, but also to desks, beds, bureaus, sofas, tables, etc. Since it's generally undesirable to swamp the user with choices, rather than display all the attributes, the CCS optionally employs one or more techniques to limit the number of attributes displayed to users to a more manageable number, for example 20 or 30 attributes. This maximum may be either preset in the CCS, or set as desired by the host.

One such technique is to give priority in the display to those attributes that apply to the greatest number of items contained within the current category level. To accomplish this, the CCS first establishes for each attribute the number of items within the current category level that are tagged with that attribute, then successively chooses the most-tagged attributes for display until the attribute-limit is reached. The CCS also includes in the display a “more” option to allow the searcher to see the next block of 20 attributes, and an “all” option to allow the searcher, if he so wishes, to see all attributes together on a scrollable page. Yet another alternative is to provide a dialogue box which allows the user to search for more attributes which may be hidden. If a desired attribute exists, then it is made available for immediate use. Otherwise, an indication is given to the searcher that such an attribute does not exist, simultaneously suggesting that the searcher try another potential attribute style search term.

Another technique is to give priority in the display to those additional attributes that are most likely to be selected by the current user, given the attributes already selected by that user during the current search or listing operation. The CCS accomplishes this by retaining a history of use (over some representative time period, such as a week or a month), keeping separate the activities of listers and searchers, and then analyzing it for correlations. For example, it may be the case that a very high proportion of searchers, having selected the “Recliner” attribute, go on to select the “UpholsteryType:Leather” attribute, while very few of them select the “BunFeet” attribute, indicating that most searchers for recliners have a high interest in specifying the type of upholstery, but don't much care what kind of feet it may have. Given these past correlations, once a searcher has selected “Recliner”, the CCS will give priority to displaying the “UpholsteryType” attribute-set, so that the searcher may make a selection from it if he chooses, but will give a low priority to displaying “BunFeet”.

Note that the same attributes might have different correlations, and thus different display priorities, if the current user is a lister. For example, it may be the case that recliners typically have bun feet, and that listers listing recliners frequently go on to specify the “BunFeet” attribute, as would be good practice, whether or not most searchers care about this attribute. In this case, the CCS would find a high correlation between listers selecting the “Recliner” attribute and then going on to select the “BunFeet” attribute, and would thus give high display priority to “BunFeet” once a lister selects “Recliner”.

Another technique employed by the CCS to enhance the usability of displayed attributes is to group together those attributes that are related to one another. CCS makes this determination by examining the set of items meeting the users currently selected categories and attributes. From these items, for all as-yet unselected attributes that are tagged to one or more of these items, the CCS establishes the degree of correlation of one attribute with another. For example, within the chair category, large numbers of items may be tagged with the attribute “Recliner” or with the tag “Armless”, but (since almost all recliners have arms) very few items will be tagged with both these attributes, giving them a low correlation index. But many items will be tagged with both “Rocker” and “SlatBack” (since many rocking chairs have slat backs), yielding a high correlation index, causing the CCS to tend to group them together.

Another technique used by the CCS to enhance usability is to track and analyze the activities of the current user during the current session, which may comprise the search for, or the listing of, multiple items. By determining the correlation between attributes selected, or specified, on prior items, the CCS can adjust the display priority of those attributes during the current search, or listing, activity. For example, suppose that a lister has previously listed chairs during the current session, and in many cases has specified “FrameType:Metal”, and in many of those cases has gone on to specify “BunFeet”. If the lister then begins listing a new item, and again specifies “Chair” and “FrameType:Metal”, the CCS, based on this listers past history, will give “BunFeet” a high display priority (even though, overall, for all listers, “BunFeet” may have a very low correlation with “FrameType:Metal”), making it easy for the current lister to again specify it if he chooses to.

As an extension of the above technique, the CCS retains history-by-user from prior sessions, and is thereby able to provide the above-described benefit at the outset of a user's session, without having to wait for patterns to emerge from the current session (as required by the above technique).

Guided attribute tagging: As described above, if the current user is a lister, attributes may be given a display priority based on their correlation with already selected attributes, as derived from the past practice of other listers, which has the effect of guiding listers to specify those additional attributes that other listers have in the past. As an alternative (or in addition, as a second pass), listers may request that the CCS use the display priorities associated with searcher activity rather than lister activity. In this way, listers are able to see things from the searcher's perspective, and to better understand the attributes that a searcher would likely select, thereby prompting the lister to specify those attributes as they apply to the current item.

The CCS also prompts listers with an “Are you sure?” query if they attempt to move off the current display if there are any attributes on that display that are correlated, from either the searcher or lister perspective, with attributes already specified, but which the current lister has failed to specify. Thus, if a lister is listing a chair, but has failed to specify the “UpholsteryType”, and if the CCS determines from the usage history that most listers and/or searchers, if they select “Chair”, also select an “UpholsteryType” attribute, the CCS will prompt the current lister to specify that attribute for the current item. The lister can of course choose to ignore the prompt.

Advanced attribute selection: As an alternative to selecting check boxes or selecting from drop down lists, the CCS optionally allows searchers to specify attributes within complex search strings using such commands as AND, OR, NOT and BUT NOT. For example, the searcher could specify the search string (Chair OR Sofa) AND Style:Contemporary AND (Upholstery:Fabric OR Upholstery:Leather) BUT NOT Color:Blue AND NOT (Armless AND Color:Red) to locate all contemporary chairs or sofas upholstered in either leather or fabric, excluding any that are blue, and also excluding any that are both armless and red.

Pruning of categories and attributes: The CCS does not simply accept blindly all categories and attributes created by the listers. At a minimum, the CCS refuses any created category or attribute that contains prohibited words or phrases, such as slurs or vulgarities. But even after a category or attribute is initially accepted into the CDB, the CCS attempts to ensure that categories and attributes that have low utility—that is, those that are infrequently used—are purged from the CDB to prevent the accumulation of “litter”. For example, if a lister, foolishly or frivolously, creates attributes in the “chair” category of “funky”, or “nice”, or “127 pounds”, it's likely that because of excessive generality, or excessive specificity, or plain irrelevance, these attributes won't be much used by either searchers, when seeking items, or subsequent listers, when tagging their own items. Therefore, the CCS keeps track of the amount of use, over time, of each category, attribute, and attribute-set member, and deletes from the CDB those that fall below an appropriate minimum.

Consolidation of categories and attributes: Certain attributes may be so strongly correlated with one another that one or more of them may be redundant. For example, if the “chair” category contained attributes for both “PlasticSeat” and “PlasticBack”, and if it should be the case that virtually all items tagged by listers with the “PlasticSeat” attribute are also tagged with the “PlasticBack” attribute, the CCS would then regard these attributes as redundant, and would combine them as “PlasticSeat,PlasticBack”.

Intelligent restructuring of categories and attributes: The CCS attempts to maintain category hierarchies that maximize the degree of convergence (the successive narrowing of the number of eligible items) achieved by a selection at each category level. By monitoring and analyzing patterns of usage, the CCS determines whether certain categories should be moved to different locations within the category hierarchy to best realize this goal. For example, suppose there is a category hierarchy of Home>Furniture>New/Used>Chairs>Style>Frametype>UpholsteryType>Color. If, in practice, 95% of the items listed under “Furniture” are new rather than used, then the “New/Used” category choice provides low convergence for those following the “New” path, and high convergence for those following the “Used” path. If the CCS determines from its ongoing analysis of usage patterns that a preponderance of searchers in fact follow the “New” path, then the CCS restructures the hierarchy to put the “New/Used” category lower in the hierarchy to allow more important—that is, more highly convergent—categories to be higher in the hierarchy. The principle used by the CCS that underlies this dynamic reorganization is to provide the greatest good to the greatest number.

Automatic Clustering (AC): This facility minimizes or eliminates the need for an SE user to successively refine his search terms in a manual fashion in order to improve the relevance of results. After a user has obtained initial search results from an SE in the usual way, AC operates by monitoring which particular result-items (from the complete set of results presented to the user) the user chooses to visit. Note that visited results represent the user's judgment, after mentally applying additional filter terms or intuition, as to which result items are relevant to his present interest. Then, whenever the user requests that more results be presented (which request may be phrased as “more”, or “refine”, or “next”), AC performs the clustering process on the set of visited results, and eliminates from the next group of returned results any results which do not fall within one or more of the derived categories in the cluster. In this way, the user's choices, and the mental selection process underlying them, is fed back into the system and used by AC to refine the results in an automated fashion.

The AC process may be performed on a remote server, which may be associated with the SE itself, using a technique such as DCLP to monitor which results the user visits. Alternatively, the monitoring may be performed on the user's computer, with the set of visited results sent to a remote server to perform the remainder of the AC process. As another alternative, the AC process may completely reside on the user's computer.

Another technique employed by AC is to retain a cluster, derived as described above, for use as a context with a subsequent, more refined, search, or for use with a new search. For example, if an initial search were performed using “soap” as the keyword, and if the user's visits to particular results allowed AC to create a set of clustered categories pertaining to hand soap and bath soap (but excluding categories pertaining to soap operas, which the user didn't visit), the user may then perform a follow-up search using “flakes” or “bubble”, requesting that the existing cluster context be applied to the new search. In this case, though the single search term “flakes” would ordinarily yield a vast number of results, most of them not related to soap, AC would only return that subset of results that also correspond to the existing context. In the example, this would by and large have the effect of limiting results to those pertaining to soap flakes or bubble bath.

As an added refinement of the above, multiple contexts may be saved within AC, allowing users to select a context (from a plurality of contexts derived from their prior searches) for use with a current search.

As another refinement, AC monitors not just which result webpages are visited, but also how extensively those webpages, and others in the same website as the original result page, are traversed, giving the greatest weight, when creating clusters, to those webpages in which the user demonstrates the greatest interest. For these purposes, the extent of traversal may be defined as the number of links clicked, the number of pages visited, the total time spent, or some combination.

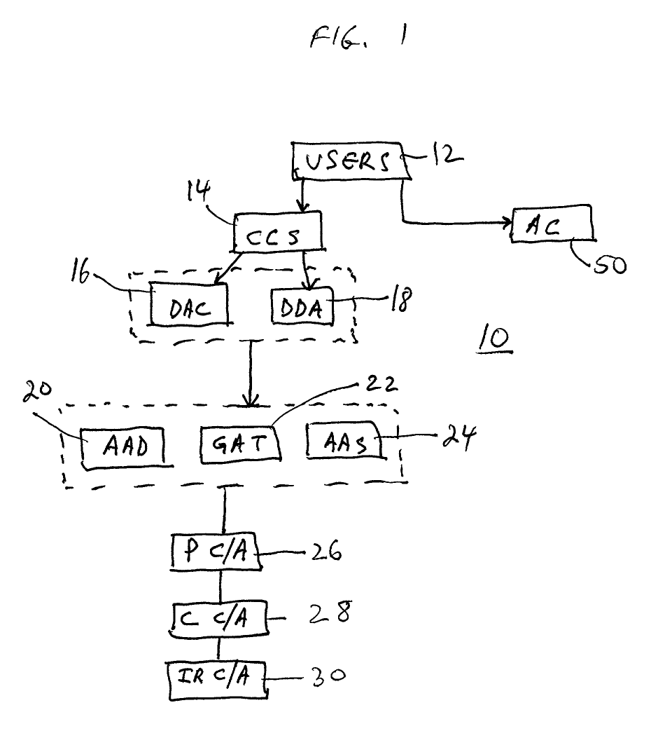

As described above, and with reference to FIG. 1, the present invention comprises a system and method that relates to the Internet and which substantially comprises an interactive and to a degree automated system that produces search categories and search attributes which facilitate the creation, indexing and searching for physical and informational items stored on Internet databases and the like. The system 10 enables users 12 comprising hosts, listers, and searchers to access, under specified conditions, the cooperative categorization system block 14 of the present invention, which comprises the hardware and associated software tools that enable attaining the objectives of the invention. The overall system comprising the cooperative categorization system 14 includes secondary software facilities that provide the different functionalities of the invention. These include the DAC 16 which enables dynamically adding categories as heretofore described and the similar facility DAA 18 which provides the functionality of dynamically adding attributes. In conjunction with the foregoing facilities, the AAD 20 (Adaptive Attribute Display) operating alone and/or in conjunction with the GAT 28 and the AAS 24, comprising, respectively, a guided attribute tagging function and an advanced attribute selection function, enable optimal display of attributes to the user of the system.

To avoid overwhelming users with a plethora of unmanageable lists of categories and attributes, the P C/A 26, providing the pooling of attributes and categories functionality; the C C/A 28, providing for the consolidation of categories and attributes, and the IR C/A 30, which constitutes the intelligent restructuring of categories and attributes module, operate individually or cooperatively, to assure a manageable display of categories and attributes as heretofore described. The system of the invention is further operable with the automatic clustering function 50 which provides improved searching capability to the users, primarily the end searchers.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. An interactive system for enhancing the searchability of data, the system comprising:
a categorization system that associates search terms defining categories or attributes with items to be found;
a communication system for communicating with the categorization system and with a store of information from which information is to be selected based on the search terms; and
a cooperative facility associated with the categorization system that enables users to interactively and at least partially automatically, modify or supplement the search terms initially assigned to the items to be found by the categorization system.

2. The interactive system of claim 1, in which the store of information is accessible via the Internet.

3. The interactive system of claim 1, in which the categorization system enables assigning search terms that are hierarchical and enables assigning search terms that are based on items to be found.

4. The interactive system of claim 1, in which the cooperative facility is accessible to the users and the users comprise listers of information and/or end searchers which search for the information.

5. The interactive system of claim 1, in which the search terms comprise categories of items to be found that are arranged hierarchically and attributes of items defined descriptively and the categorization and attribute information is stored in a categorization and attribute database.

6. The interactive system of claim 1, including a facility that dynamically enables a lister of items in the store of information to use existing categorization and attribute data and to add additional categories via the cooperative facility.

7. The interactive system of claim 1, including a facility that dynamically enables a searcher of items in the store of information to use existing categorization and attribute data and to add additional attributes via the cooperative facility.

8. The interactive system of claim 7, including a facility that is operable in conjunction with the cooperative facility to limit the number of attributes displayed to users upon their initial viewing of available attributes.

9. The interactive system of claim 8, in which the number of displayed attributes is less than 30.

10. The interactive system of claim 8, in which the displayed attributes are selected based on the greatest number of items under a current category.

11. The interactive system of claim 8, in which the displayed attributes are selected based on prior searchers' activities.

12. The interactive system of claim 8, wherein displayed attributes are selected based on a current searcher's search history.

13. The interactive system of claim 8, in which displayed attributes are ordered based on aggregate use of attribute search terms by prior searchers.

14. The interactive system of claim 1, including a facility that groups together those attributes that are related to one another.

15. The interactive system of claim 1, including a facility that enable searchers to specify attribute selections by entry of a plurality of terms connected by Boolean expressions.

16. The interactive system of claim 1, wherein the cooperative facility includes a secondary facility that imposes limitations on types of attributes permitted to be added to the database holding the attributes.

17. The interactive system of claim 1, in which the cooperative facility includes a subsidiary facility that removes redundancies in categorization and attribute search terms.

18. The interactive system of claim 1, wherein the cooperative facility includes an intelligent restructuring of categories and attributes facility that iteratively reviews the categorization and attribute data to maintain hierarchies that maximize the degree of convergence achieved by a selection at each category level.

19. The interactive system of claim 2, in which the categorization system enables assigning search terms that are hierarchical and enables assigning search terms that are based on item attributes.

20. The interactive system of claim 2, in which the cooperative facility is accessible to the users and the users comprise listers of information and/or end searchers which search for the information.

21. The interactive system of claim 2, in which the search terms comprise categories of items to be found that are arranged hierarchically and attributes of items defined descriptively and the categorization and attribute information is stored in a categorization and attribute database.

22. The interactive system of claim 2, including a facility that dynamically enables a lister of items in the store of information to use existing categorization and attribute data and to add additional categories via the cooperative facility.

23. The interactive system of claim 2, including a facility that dynamically enables a searcher of items in the store of information to use existing categorization and attribute data and to add additional attributes via the cooperative facility.

24. The interactive system of claim 2, including a facility that groups together those attributes that are related to one another.

25. The interactive system of claim 2, including a facility that enable searchers to specify attribute selections by entry of a plurality of terms connected by Boolean expressions.

26. The interactive system of claim 2, wherein the cooperative facility includes a secondary facility that imposes limitations on types of attributes permitted to be added to the database holding the attributes.

27. The interactive system of claim 2, in which the cooperative facility includes a subsidiary facility that removes redundancies in categorization and attribute search terms.

28. The interactive system of claim 2, wherein the cooperative facility includes an intelligent restructuring of categories and attributes facility that iteratively reviews the categorization and attribute data to maintain hierarchies that maximize the degree of convergence achieved by a selection at each category level.

29. The interactive system of claim 1, in combination with an automatic clustering facility that minimizes the need of a search engine user to successively refine search terms in a manual fashion, by 00545069 1 00544730.1 monitoring which particular result-items a user has historically chosen to visit.

30. A method for searching for data items in a data store, the method comprising the steps of:
operating a computer-based communication system that effects communications between a plurality of data searchers and the data store containing the data items;
operating a search engine that enables the data searchers to enter initial key words describing data items to be found;
receiving selected data items that are responsive to the initial key words in a given order of items, organized into successive viewable pages;
initiating a manual review of the received selected data items; and
operating an automatic clustering tool that is responsive to the items manually perused by the data searcher, including items not reviewed by the data searcher, the automatic clustering tool responding to the user's action by interactively creating categorization criteria by which at least a portion of the received selected data items are reordered or filtered for being viewed by the data searcher, and/or by which a further search is performed and results are based thereon.

31. The method of claim 30, in which the automatic clustering tool responds to a searcher's data item perusal activity in a prior session.

32. The method of claim 30, in which the automatic clustering tool constantly revises the categorization criteria in response to continuous reviewing of the selected data items by the data searcher.

33. The method of claim 30, in which the automatic clustering tool is responsive to a given data searcher's reviewing activity over a period of time.

34. The method of claim 30, in which the automatic clustering tool eliminates selected data items from being viewed by the data searcher, based on the successively created categorization criteria.

35. The method of claim 30, including creating search context for a search session and saving search context from a prior search session to a subsequent search session.
